(19) United States
(12) Patent Application Publication
(10) Pub. No.: US 2011/0018471 A1
(43) Pub. Date: Jan. 27, 2011

(54) Method for Regulating the Angular Velocity of Printing Cylinders

(75) Inventor: Patrick Lepeltier, Angicourt (FR)

Correspondence Address: Davidson, Davidson & Kappel, LLC, 485 7th Avenue, 14th Floor, New York, NY, 10018, US

(73) Assignee: GOSS INTERNATIONAL MONTATAIRE SA, Montataire (FR)

(21) Appl. No.: 12/837,280

(22) Filed: Jul. 15, 2010

(30) Foreign Application Priority Data
Jul. 15, 2009 (FR) 09 54890

(51) Int. Cl. H02P 5/52

(52) U.S. Cl. 318/8

(57) ABSTRACT

A method for regulating a first printing unit is provided. The first printing unit includes a plate cylinder, a first blanket cylinder carrying a tubular blanket and an impression cylinder. The first blanket cylinder defines a region of contact with the plate cylinder. The impression cylinder defines a region of counter-pressure with the first blanket cylinder. The method includes when the first printing unit is printing, a regulating step of a duration greater than or equal to six minutes in respect of the angular printing velocity ω1 of the first blanket cylinder relative to the angular printing velocity ω2 of the plate cylinder so that, for at least part of the duration of the regulating step, the ratio ω1/ω2 of the angular velocities is different from the ratio D2/D 1 between the diameter D2 of the plate cylinder and the diameter D1 of the first blanket cylinder in order to define a difference in velocity Δω=ω1−ω2×D2/D1, any difference in velocity Δωbeing of the same sign throughout the entire duration of the regulating step.

This claims the benefit of French Patent Application No. 09 54890, filed on Jul. 15, 2009 and hereby incorporated by reference herein.

The present invention relates to a method for regulating the angular velocity of printing cylinders of printing units. The present invention is applicable in particular to rotary web offset presses.

### BACKGROUND OF THE INVENTION

A method for regulating the register of a printing unit is known from the document EP 1 048 461 B1. Another document EP 1 364 780 A2 describes a method in which, during a maintenance phase, a plate cylinder is driven at a rate of rotation different from that of an associated blanket cylinder.

One of the known problems of the offset printing process is the soiling of the blankets, which brings about a reduction in the surface area of the printed dots, a phenomenon which is often referred to as “dot vanishing”. The blankets are soiled by the deposition, at the non-printing sites of the blankets, of a small amount of ink which dries and which is not transferred to the paper. Paper dust may also become mixed with the dried ink. This ink and paper dust deposit surrounds the fresh ink dot and gradually reduces its size. The reduction in the size of the dots brings about a variation in the shade of the print which is then no longer within the acceptable tolerances of the printing process. The accumulation of ink and paper dust may also become so thick that the blanket is crushed to a greater extent than it can tolerate and is destroyed.

One method of reducing the dot vanishing phenomenon is taught by the patent EP 1 048 461 B1 mentioned above. In that patent, it is proposed to reduce the phenomenon by bringing about a slight lateral movement and an alternating phase shift between the plate and the blanket, so that fresh ink cleans the dry ink. This is effected by shifting the circumferential register and the lateral register of the printing unit in a regular manner. One disadvantage of that known method is that the blanket can be cleaned only in a region having a small surface area, of the order of a few millimetres, bearing in mind the limited travel of the circumferential and lateral registers.

### SUMMARY OF THE INVENTION

A first object of the invention is therefore provides a method permitting efficient and excellently controlled cleaning of the blanket of a blanket cylinder.

Another problem of offset printing arises in offset printing machines that print on a web of paper. Those printing machines have several printing units, each printing unit having its own blanket cylinder with an associated blanket. It is found that the length of the web of paper fed by a printing unit for one rotation of its associated blanket cylinder depends on the characteristics of the blanket present on the blanket cylinder. The rate of feed of the paper web varies in accordance with the behavior of the blanket when it is compressed between the blanket cylinder and the paper web. That difference in blanket behavior from one printing unit to another has an effect on the tension in the paper web segment located between two printing units. The various tensions between printing units may in turn bring about differences in the width of the paper web from the inlet of one printing unit to another (this phenomenon is referred to as the “Poisson effect”). This leads to poor superposition of the images printed by the various printing units in the direction perpendicular to the travel of the paper web.

One method of avoiding that problem is to associate with each blanket a parameter, called the feed coefficient, which is a function of its behavior relative to the rate of feed of the paper. The feed coefficient of a blanket is preferably established by measuring its dimensional characteristics or its rigidity, or by measuring, on a test bench, the relative velocity between two cylinders which are in contact with each other and one of which carries the blanket to be measured. In the majority of cases, the feed coefficient is a qualitative parameter reflecting the more or less good behavior of the blanket. The feed coefficient may then correspond to a letter (A, B, C, D, . . . ) indicating the quality of the behavior of the blanket. Nevertheless, the feed coefficient may also be a quantitative parameter indicated by a number.

The blankets are mounted in a recommended order on the various printing units of the printing machine, in accordance with their feed coefficient. However, the stipulation of a precise order for mounting the blankets renders the mounting operation tedious, laborious and inflexible. Furthermore, the feed coefficient of a blanket varies in the course of its use, for example owing to the deterioration in the microbubbles contained in its compressible layer, or owing to the continuous action of the solvents, inks and cleaning products on the blanket. That makes it difficult to change a single blanket which has been destroyed accidentally.

A second object of the invention is therefore to provide a method ensuring correct superposition of the printed images in a reliable, simple and flexible manner.

In the context of a printing unit having two blanket cylinders defining a contact region, the differences in the feed coefficient between blankets causes an additional problem because the differences in the feed coefficient bring about a difference between the torques to be provided by the various motors of the printing cylinders of the printing unit. That makes it necessary to equip the printing unit with more powerful motors than necessary and renders the regulation of the motors more difficult.

A third object of the invention is therefore to provide a method which, in a printing unit, permits the use of less powerful motors and renders the regulation of the motors more simple.

A problem to be solved by the invention is to enhance the printing quality using economical means.

The above objects may be achieved by a method for regulating a first printing unit of the type comprising:

a plate cylinder;

a first blanket cylinder which is suitable for carrying a tubular blanket and which defines a region of contact with the plate cylinder;

an impression cylinder defining a region of counter-pressure with the first blanket cylinder,

the method comprising, when the first printing unit is printing, a regulating step of a duration greater than or equal to six minutes:
A) in respect of the angular printing velocity col of the first blanket cylinder relative to the angular printing velocity ω2 of the plate cylinder so that, for at least part of the duration of the regulating step, the ratio ω1/ω2 of those angular velocities is different from the ratio D2/D1 between the nominal diameter D2 of the plate cylinder and the nominal diameter D1 of the first blanket cylinder in order to define a difference in velocity Δω=ω1−ω2×D2/D1, any difference in velocity Δω being of the same sign throughout the entire duration of the regulating step; and/or
B) in respect of the angular printing velocity ω1 of the impression cylinder relative to the angular printing velocity ω2 of the first blanket cylinder so that, for at least part of the duration of the regulating step, the ratio ω1/ω2 of those angular velocities is different from the ratio D2/D1 between the nominal diameter D2 of the first blanket cylinder and the nominal diameter D1 of the impression cylinder in order to define a difference in velocity Δω=ω1−ω2×D2/D1, any difference in velocity Δω being of the same sign throughout the entire duration of the regulating step; and/or
C) the method being a method for regulating a rotary web press comprising the first printing unit and a second printing unit, the second printing unit comprising a blanket cylinder, the said regulating step comprising the regulation of the angular printing velocity ω1 of the blanket cylinder of the second printing unit relative to the angular printing velocity ω2 of the first blanket cylinder of the first printing unit so that, for at least part of the duration of the regulating step, the ratio ω1/ω2 of those angular velocities is different from the ratio D2/D1 between the nominal diameter D2 of the first blanket cylinder of the first printing unit and the nominal diameter D1 of the blanket cylinder of the second printing unit in order to define a difference in velocity Δω=ω1−ω2×D2/D1, any difference in velocity Δω being of the same sign throughout the entire duration of the regulating step.

In the context of the invention, what is meant by the angular velocity of a cylinder is the rate of rotation of the cylinder in radians per second (rad/s).

By regulating the angular velocity of two printing cylinders in order to ensure a difference in velocity of constant sign between the two cylinders, an increasing phase shift is obtained between the two cylinders.

When the two cylinders correspond to a plate cylinder and to a blanket cylinder carrying a tubular blanket, the increasing phase shift indicates a continuous displacement of the image on the blanket, so that fresh ink resorbs the dry ink. As a result, the blanket is cleaned evenly over its entire surface.

When the two cylinders correspond to two cooperating blanket cylinders from the same printing unit, the difference in angular velocity enables the difference between the feed coefficients of the two blankets to be compensated for in order to equalize the motor torques to be provided.

When the two cylinders correspond to two blanket cylinders from two different printing units, the difference in angular velocity enables the tension of the paper web between the two printing units to be maintained at a desired value.

According to particular embodiments, the regulating method according to the invention comprises one or more of the following features, taken individually or in accordance with any technically possible combination:
the first blanket cylinder and the plate cylinder being in contact in their contact region for the transmission of an image to be printed from the plate cylinder to the first blanket cylinder, the difference in velocity Δω between the first blanket cylinder and the plate cylinder is regulated in such a manner as to obtain an increasing monotonic or decreasing monotonic circumferential shift between those two cylinders, thus avoiding a local accumulation of ink and dust over the entire periphery of the blanket;
the impression cylinder is a second blanket cylinder, the counter-pressure region of the two blanket cylinders being a region for nipping a web to be printed, and wherein the difference in velocity Δω between those two blanket cylinders is regulated in such a manner as to reduce the difference between the torque provided by a drive means of the first blanket cylinder and the torque provided by a drive means of the second blanket cylinder;
the first printing unit and the second printing unit being two consecutive units and the first blanket cylinder of the first printing unit and the blanket cylinder of the second printing unit being suitable for each printing a partial image on the same side of the web, the difference in velocity Δω between the first blanket cylinder of the first printing unit and the blanket cylinder of the second printing unit is regulated in such a manner as to keep constant, or to regulate to a predetermined value, the tension of the web between the first printing unit and the second printing unit;
the two cylinders which define the difference in velocity Δω have, in particular, the same nominal diameter, and wherein the difference in velocity Δω between those two cylinders is brought about by driving the two cylinders in such a manner that, when one of the two cylinders has performed a set number n of rotations, n being an integer from 1 to 5000, the other cylinder has performed either n rotations plus a predetermined angular adaptation value, or n rotations minus a predetermined angular adaptation value;
the angular adaptation value is determined empirically by observation, preferably using sensors associated with the printing unit(s);
in order to bring about the difference in velocity Δω between the two blanket cylinders, the angular adaptation value is determined as a function of a feed coefficient C1 associated with the blanket of one of the two blanket cylinders, and as a function of a feed coefficient C2 associated with the blanket of the other blanket cylinder, each feed coefficient indicating the guiding behavior of the associated blanket relative to a web to be printed;
the angular adaptation value is a function of the difference between the feed coefficient C1 and the feed coefficient C2;
a difference in angular velocity between the first blanket cylinder and the plate cylinder is brought about by means of a first predetermined angular adaptation value, and at the same time a difference in angular velocity between the first blanket cylinder and the impression cylinder is brought about by means of a second predetermined angular adaptation value, the second angular adaptation value being different from the first angular adaptation value;
at the same time a difference in angular velocity between the blanket cylinder of the second printing unit and the first blanket cylinder of the first printing unit is brought about by means of a third predetermined angular adaptation value, the third angular adaptation value being different from the first angular adaptation value and from the second angular adaptation value;
the or each angular adaptation value is from 2.5×−6 to 2.5×10−5 radians, and is, in particular, of the order of 5×10−6 radians and/or corresponds to an adaptation distance on the circumference of the associated cylinder which is from 0.5 μm to 5 μm;
the plate cylinder is driven individually by its own motor, and wherein the first blanket cylinder and the impression cylinder are driven either by a common motor or by two individual motors, the or each difference in velocity Δω being obtained by regulating those motors;
during the printing operation, the or each blanket is secured to its associated blanket cylinder in a manner which is immobile in the circumferential direction relative to the blanket cylinder;
   |Δω|=|ω1−ω2×D2/D1|>0 throughout the entire duration of the regulating step;
the regulating step comprises at least two regulating sub-steps during which |Δω|>0 and at least one synchronous sub-step during which Δω=0, and preferably wherein two regulating sub-steps delimit the regulating step.

The invention also provides a device for regulating the angular velocity of one or more printing cylinders in a printing machine, the device being suitable for carrying out a regulating method such as defined above.

In addition, the invention further provides software for regulating the angular velocity of one or more printing cylinders in a printing machine, the software being suitable for implementing a regulating method such as defined above.

### BRIEF DESCRIPTION OF THE DRAWINGS

The invention will be better understood on reading the following description which is given purely by way of example and with reference to the appended drawings.

FIG. 1 is a side view of a printing machine in which the regulating method according to the invention is implemented;

FIG. 2 is a diagram showing the rotation performed by a first cylinder when a second cylinder has performed one complete rotation; and

FIG. 3 gives three examples of the variation over time of the difference in angular velocity between two cylinders according to the invention.

### DETAILED DESCRIPTION

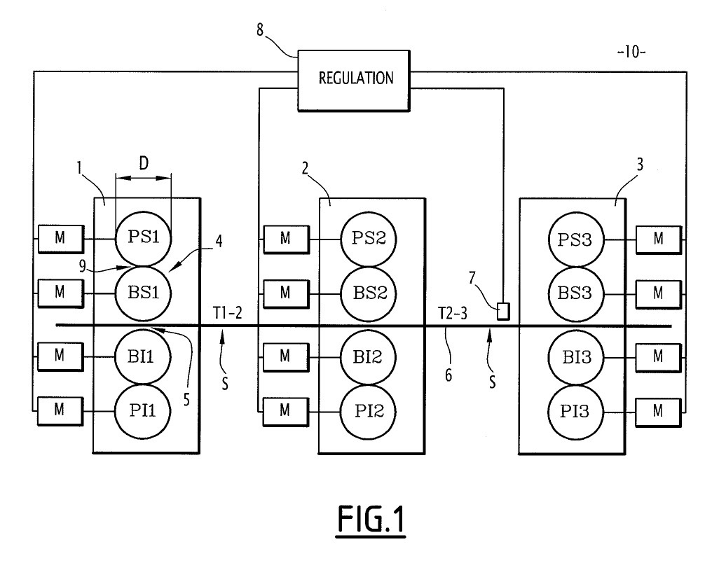

FIG. 1 illustrates a printing machine 10. This printing machine 10 comprises three offset printing units 1, 2 and 3. Each printing unit is used to print a partial image of a specific color on the two faces of a paper web 6 passing through it.

Each printing unit comprises four printing cylinders, namely an upper plate cylinder ps, an upper blanket cylinder bs, a lower blanket cylinder bi, and a lower plate cylinder pi. The suffix 1, 2 or 3 of the reference sign of a particular cylinder indicates its membership of one of the three printing units. For example, the reference sign bs2 denotes the upper blanket cylinder of the printing unit 2. In the embodiment illustrated in FIG. 1, each printing cylinder of the printing machine 10 has substantially the same diameter D. Nevertheless, the invention is also applicable to printing machines having printing cylinders with different diameters.

The region for nipping the paper web between two, upper and lower, blanket cylinders is indicated by the reference 5, the region of contact between a plate cylinder and a blanket cylinder by the reference 9, and the blanket of a blanket cylinder by the reference 4.

The plate cylinders ps, pi are provided with a transverse groove which enables the printing plate to be suspended. The blanket cylinders bs, bi do not have a groove, a tubular blanket being slipped onto each blanket cylinder and tightened.

Each blanket 4 is completely immobile in the circumferential direction on the associated blanket cylinder. In other words, the blanket 4 is not shifted on its blanket cylinder during the printing operation.

Each printing unit 1, 2, 3 also comprises four motors M, each motor M being associated exclusively with one of the cylinders and being used to drive that cylinder. In another variant of the invention, which is not shown, the two blanket cylinders bs, bi of a printing unit may be driven by the same motor, while each of the two plate cylinders is driven by an individual motor.

The printing machine 10 also comprises a regulating device 8, in general an electronic device such as a computer. That regulating device 8 is connected to the motors M in order to regulate the operation thereof and thus the angular velocity ω of each of the printing cylinders.

The regulating device 8 is also connected to a plurality of sensors 7, one of which is shown in FIG. 1. Those sensors 7 measure different printing parameters, such as the tension T1-2, T2-3, or the width of the paper web 6, the distance between the dots of different colors printed by the various printing units, or also the torques of the motors M.

In general, and in known manner, when the printing machine 10 is printing, the regulating device 8 ensures that all of the printing cylinders have the same angular velocity ω.

According to the invention, the regulating device 8 is also suitable for introducing differences in angular velocity between the cylinders. For the purposes of the present description, the cylinders of the machine 10 are considered in sets of two cylinders, each set being made up of a first and a second cylinder.

The embodiment described hereinafter refers to a first and a second cylinder having the same nominal diameter. The nominal diameter is a function of the printing length. For identical circumferential velocities, the two cylinders have identical angular velocities, when they have the same nominal diameters.

If the first and second cylinders have nominal diameters which differ from each other, at identical circumferential velocities, the angular velocity of the first cylinder is D2/D1 of the angular velocity of the second cylinder, D1 being the nominal diameter of the first cylinder and D2 being the nominal diameter of the second cylinder (ω1=ω2×D2/D1). In that case, the angular velocity ω2 must therefore be multiplied by a correction factor FC=D2/D1. Preferably, the correction factor meets the following criterion FC=D2/D1=p/q, where p;q are [1; 2; 3; 4; 5]. Preferably, also FC=D2/D1 or D1/D2 being equal to an integer.

In reality, the actual outside diameters of the cylinders do not strictly meet those criteria in every case, the plate cylinder having a diameter slightly different from the diameter of the blanket cylinder. In that case, the numbers p and q are the number of pages arranged on the circumference of the cylinder concerned. For example, if the plate cylinder comprises three printing pages on its circumference and the blanket cylinder comprises two printing pages, p=3 and q=2, that is to say, FC=3/2.

The regulating device is suitable for regulating the angular velocities in such a manner that a first of the printing cylinders rotates at an angular velocity ω1 slightly different from the angular velocity ω2 of a second of the printing cylinders.

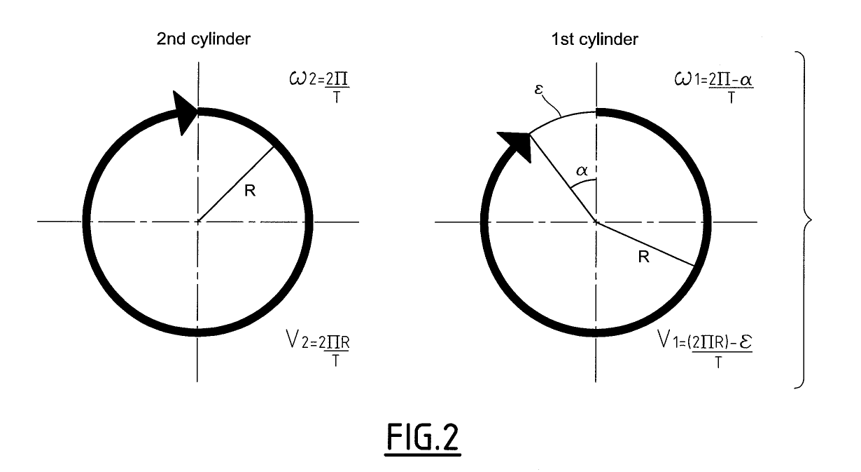

An embodiment of that difference in velocity col ω1−ω2=Δω is illustrated by FIG. 2. Over a time interval T, the second cylinder performs one complete rotation. Consequently, its angular velocity ω2 is 2π/T. Its associated circumferential velocity is V2=2πR/T, where R is the radius of the cylinder. During the same time T, the first cylinder performs one complete rotation minus a distance Epsilon (ε). That distance Epsilon is an arc of a circle with an associated angle α. The angular velocity col of the first cylinder is therefore (2π−ε)/T, and its circumferential velocity V1 is (2πR−ε)/T. The angle α may be qualified as an angular adaptation value.

In a variant, it would also be possible to regulate the angular velocities of the two cylinders in such a manner that, during the time T, the second cylinder always performs one complete rotation, while the first cylinder performs one complete rotation plus an angle α (that is to say, plus a distance Epsilon (ε)). More generally, it is possible to regulate the angular velocity of the one or the two printing cylinders in such a manner that, when the second cylinder has performed a number n of rotations, n being an integer from 1 to 5000, the first cylinder has performed either n rotations plus a predetermined angle alpha (α), or n rotations minus a predetermined angle alpha (α).

The choice of the alpha or Epsilon value will differ in accordance with the nature of the two printing cylinders and the intended purpose.

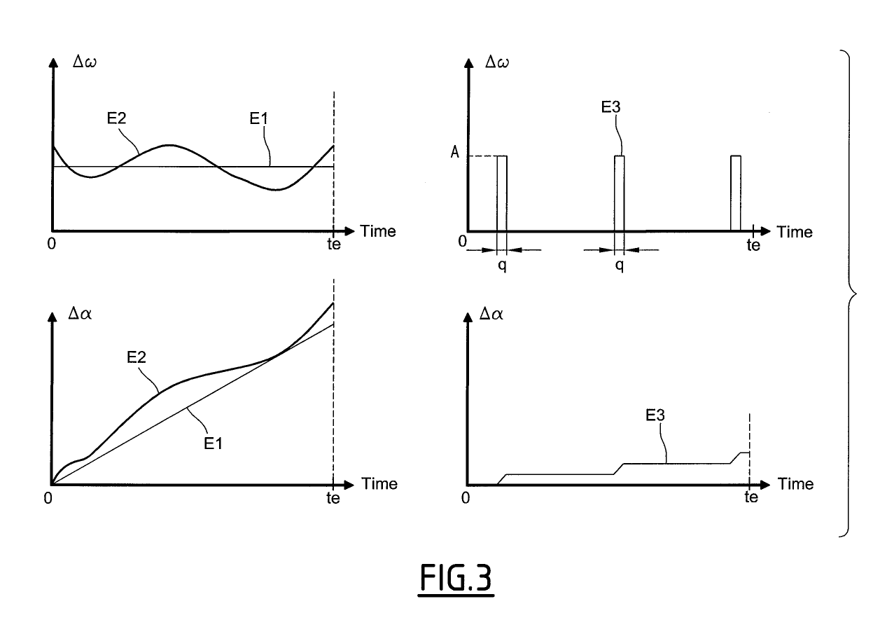

FIG. 3 is a representation of three different examples of the regulation over time of the difference in angular velocity Δω between two printing cylinders. In each of these examples, Δω is regulated during a regulating step of a duration te greater than or equal to six minutes. Preferably, the duration te is identical to the duration of the print job. The lower graphs in FIG. 3 illustrate the evolution over time of the angular phase shift Δα between the two cylinders, while the upper graphs illustrate the corresponding evolution of Δω.

According to the first example, marked E1, Δω is constant throughout the entire regulating step, so that the evolution of Δα corresponds to a straight line. According to the second example, marked E2, the evolution of Δω corresponds to an oscillating curve having several maxima and minima. Those two examples have in common that the absolute value |Δω|>0 throughout the entire duration of the regulating step.

In the third example, marked E3, a difference in velocity |Δω|>0 is generated in a periodic manner during regulating sub-steps of a duration q less than te. Each regulating sub-step is followed by a synchronous sub-step where Δω is substantially equal to 0. In the case of this Figure, the evolution of Δα takes the form of a sequence of plateaus connected by slopes. The slopes correspond to steps of circumferential slippage between the two cylinders. Preferably, as illustrated in FIG. 3, the duration q and the amplitude A of the generation of the differences in velocity Δω are always the same. Nevertheless, it would be possible to consider varying q and A from one generation to another. Furthermore, the differences in velocity Δω may also be generated in a non-periodic manner, and in particular in a random manner.

Therefore, preferably, two regulating sub-steps delimit the regulating step. In other words, the start and the finish of the regulating step coincide with a regulating sub-step.

The three examples of FIG. 3 have in common that any difference in velocity Δω applied in the course of the regulating step is always of the same sign throughout the entire duration to of the regulating step. Thus, in the course of the regulating step, the phase shift Δα increases or remains constant, but never decreases.

The three examples of FIG. 3 are not limiting; other evolution profiles of Δω may be considered.

### First Embodiment

### Optimization of the Cleaning of the Blanket

In a first embodiment, the first and the second cylinder for which a difference in angular velocity is generated are, within the same printing unit, a blanket cylinder and its associated plate cylinder, respectively. For example, they may be the cylinders bs1 and ps1 of the printing unit 1, or the cylinders bi3 and pi3 of the printing unit 3.

An object here is to obtain efficient cleaning of the blanket of the blanket cylinder. To that end, the adaptation value alpha α (or Epsilon ε) is set at a value sufficiently high to ensure efficient cleaning of the blanket. At the same time, the value of alpha a (or of Epsilon) is set at a value sufficiently low not to cause interference with the printing quality. Experiments have shown that the preferred range, in particular for cylinders having a diameter of, for example, approximately 400 mm, for alpha extends from 2.5×10−6 to 2.5×10−5 radians, which corresponds to an Epsilon range of from 0.5 to 5 μm. In a particularly preferred manner, alpha is of the order of 5×10−6 radians per rotation of the cylinder, which corresponds to a value of Epsilon ε of the order of 1 μm per rotation of the cylinder. It is above all the Epsilon value which is important; the alpha value will be a function of the diameter of the cylinder.

Owing to the resultant difference in velocity between the plate cylinder and the blanket cylinder, in the course of the printing operation, the image is displaced slowly on the surface of the blanket, and this continuously eliminates the dust and dried ink.

It should be noted that this cleaning method is specifically suited to a tubular blanket. The regulating step is applied for a sufficiently long period of time for the circumferential shift between the two cylinders to reach a value which exceeds the circumferential size of the transverse groove in the plate cylinder. Such a shift would not be tolerable if the blanket were a discontinuous blanket, because there would no longer be the necessary superposition between the groove of the plate cylinder and that of the blanket cylinder.

### Second Embodiment

### Ensuring Correct Superposition of the Printed Images

In this embodiment, the first cylinder corresponds to a blanket cylinder of a first printing unit, and the second cylinder corresponds to a blanket cylinder of a second printing unit. The first cylinder carries a first blanket with a feed coefficient C1, while the second cylinder carries a second blanket with a feed coefficient C2.

The object of this embodiment is to keep the tension prevailing in a segment S of paper web 6 located between two printing units at a desired value in order to ensure correct superposition of the images printed by each printing unit. To that end, the value of alpha (or of Epsilon) is chosen to compensate for the difference C1−C2 between the feed coefficients of the two blankets.

For example, if the feed coefficient of one blanket gives an exact figure for the deviation of the paper feed rate for one rotation of the cylinder relative to the theoretical feed rate, then Epsilon=C1−C2.

With the resultant difference in velocity between the blanket cylinder of the first printing unit and the blanket cylinder of the second printing unit, the difference in behavior from one blanket to the other is compensated for. Thus, the tension of the paper web between two printing units 1, 2, 3 is kept at a desired value. Of course, such a variation in the angular velocity of blanket cylinders from one printing unit to another is not possible unless the angular velocity of the plate cylinders remains equal for all of the printing units. Otherwise, there would be an increasing shift between the images printed by the various printing units.

The printing machine 10 illustrated in FIG. 1 comprises three printing units 1, 2, 3. In this context, it will be necessary to calculate two values of Epsilon (or of alpha). A value Epsilon 1 will be calculated to regulate the tension T1-2 of the paper web 6 between the first printing unit 1 and the second printing unit 2. A value Epsilon 2 will be calculated to regulate the tension T2-3 of the paper web 6 between the second printing unit 2 and the third printing unit 3.

Preferably, Epsilon 1 and Epsilon 2 are calculated in accordance with the following equations:

Epsilon 1=Cm1−Cm2;

Epsilon 2=Cm2−Cm3;

where Cm1 corresponds to the arithmetical mean of the feed coefficients of the two blankets of the printing unit 1, Cm2 corresponds to the arithmetical mean of the feed coefficients of the two blankets of the printing unit 2, and Cm3 corresponds to the arithmetical mean of the feed coefficients of the two blankets of the printing unit 3.

Epsilon 1 is then applied to the angular velocity of the cylinders bs2 and bi2, and Epsilon 2 is applied to the angular velocity of the cylinders bs3 and bi3. Thus, when the cylinders bs1 and bi1 perform one complete rotation, the cylinders bs2 and bi2 perform one complete rotation minus Epsilon 1, and the cylinders bs3 and bi3 perform one complete rotation minus Epsilon 2. In other words, the two blanket cylinders of the printing unit 1 then rotate at a first velocity cob 1, the two blanket cylinders of the printing unit 2 rotate at a velocity ωb2 slightly lower than ωb1, and the two blanket cylinders of the printing unit 3 rotate at a velocity ωb3 slightly lower than ωb1 and different from ωb2. Epsilon may be positive or negative according to the characteristics of the blankets.

### Third Embodiment

### Permitting the Use of Less Powerful Motors

In this embodiment, the first and the second cylinder correspond to the upper blanket cylinder and to the lower blanket cylinder, respectively, of the same printing unit. The first cylinder carries a first blanket with a feed coefficient C1, while the second cylinder carries a second blanket with a feed coefficient C2. Those cylinders may be, for example, the cylinders bs2 and bit of the printing unit 2, or the cylinders bs3 and bi3 of the printing unit 3.

An object here is to optimize the distribution of the motor torques within the same printing unit. To that end, the value of Epsilon is chosen to compensate for the difference C1−C2 between the feed coefficients of the two blankets.

For example, if the feed coefficient of one blanket represents exactly the deviation of the paper feed rate for one rotation of the cylinder relative to the theoretical feed rate, then Epsilon=C1−C2.

With the resultant slight difference in velocity between the upper blanket cylinder and the lower blanket cylinder, the difference in behavior from one blanket to the other is compensated for. Thus, the torques Ks, Ki of the motors of the blanket cylinders of the same printing unit are equalized.

### General Observations

Although the three embodiments have been described separately, they may also be combined in various manners.

For example, it would be possible to combine the first embodiment with the third in order to obtain a cleaning of the blankets and simultaneously an equalization of the motor torques. It is also possible to apply all three embodiments at the same time.

In the case of a combination of at least two embodiments, it is advantageous to define a threshold epsilon value.

For the first embodiment, a minimum threshold epsilon value is defined, which guarantees a correct cleaning of the blankets. In that case, firstly the epsilon values are determined for each set of cylinders in accordance with the above methods. Secondly, for each set of cylinders, a check is carried out to establish whether the associated epsilon value is above the minimum threshold epsilon value. If any of the epsilon values is below the minimum threshold epsilon value, the or each epsilon value below that threshold epsilon value is increased. In that case, preferably, all of the epsilon values are increased by the same value and to a sufficient extent to ensure that no epsilon value is below the minimum threshold epsilon value.

Likewise, a maximum threshold epsilon value may be defined which corresponds to a difference in velocity beyond which a doubling between two printing units is observed. When all of the epsilon values have been established in accordance with one or more of the above methods, a check is carried out to establish whether any of the epsilon values is above the maximum threshold epsilon value. If that is the case, the or each epsilon value above the maximum threshold epsilon value is decreased so as to be equal to or less than the maximum threshold epsilon value. Preferably, all of the epsilon values are decreased by the same value and to a sufficient extent to ensure that no epsilon value is above the maximum threshold epsilon value.

The above Epsilon calculations are given by way of example and other methods of calculating Epsilon may be considered. Preferably, these calculations are carried out by the regulating device 8.

It is also possible to arrive at the appropriate difference in angular velocity by methods other than the calculation of one or more Epsilon values; the angular velocities of the cylinders could also be adjusted manually by the operator so as to reduce or eliminate the defects found. The operator could, for example, adjust the angular velocities until the dot vanishing phenomenon disappeared, and/or until the correct tension of the paper web segment S was obtained between two printing units, and/or until the torques provided by the motors of the same unit were equalized.

The method according to the invention modifies the mechanical tension of the web between two printing units in such a manner that this tension is close to the mechanical tension of the web between two other printing units, in particular by increasing it or reducing it.

The angular velocities or the epsilon values could also be adjusted automatically by the regulating device 8, using sensors, such as the sensor 7. Those sensors can measure the tension T1-2, T2-3 of the web 6 between the various printing units 1, 2, 3. They can also measure the width of the web 6 between the various printing units 1, 2, 3, or the distances between the dots of different colors printed by the various printing units 1, 2, 3. The sensors could also measure the torques of the motors M or the size of the printed dots.

What is claimed is:

1-17. (canceled)

18. A method for regulating a first printing unit, the first print unit including:
a plate cylinder having a first plate angular printing velocity ω2 and a first plate nominal diameter D2,
a first blanket cylinder carrying a tubular blanket and defining a region of contact with the plate cylinder, the first blanket cylinder having a first blanket angular printing velocity ω1 and a first blanket nominal diameter D1; and
an impression cylinder defining a region of counter-pressure with the first blanket cylinder, the impression cylinder having an impression angular printing velocity ω3 and an impression nominal diameter D3,
the method comprising the step of:
regulating for a duration greater than or equal to six minutes when the first printing unit is printing:
A) a ratio ω1/ω2 of the angular velocities being different from a ratio D2/D1 of the nominal diameters to define a difference in velocity as Δω=ω1−ω2×D2/D1 for at least part of the duration, any difference in velocity Δω being of a same sign throughout the entire duration; and/or
B) the ratio ω3/ω1 of the angular velocities being different from the ratio D1/D3 of the nominal diameters to define a difference in velocity Δω=ω3−ω1×D1/D3 for at least part of the duration, any difference in velocity Δω being of a same sign throughout the entire duration.

19. The method according to claim 18, wherein the first blanket cylinder and the plate cylinder are in contact in the contact region for transmission of an image to be printed from the plate cylinder to the first blanket cylinder, the difference in velocity Δω between the first blanket cylinder and the plate cylinder being regulated to obtain an increasing monotonic or decreasing monotonic circumferential shift between the plate and blanket cylinders to avoid a local accumulation of ink and dust over an entire periphery of the blanket.

20. The method according to claim 18, wherein the impression cylinder is a second blanket cylinder, the counter-pressure region of the first and second blanket cylinders being a region for nipping a web to be printed, the difference in velocity Δω between the first and second blanket cylinders being regulated to reduce the difference between a torque of a first drive of the first blanket cylinder and a torque of a second drive of the second blanket cylinder.

21. The method according to claim 18, wherein the two cylinders which define the difference in velocity Δω have the same nominal diameter, and wherein the difference in velocity Δω between the two cylinders is brought about by driving the two cylinders in such a manner that, when one of the two cylinders has performed a set number n of rotations, n being an integer from 1 to 5000, the other cylinder has performed either n rotations plus a predetermined angular adaptation value or n rotations minus a predetermined angular adaptation value.

22. The method according to claim 21, wherein the angular adaptation value is determined empirically by observation and/or using sensors associated with the printing unit.

23. The method according to claim 21, wherein the impression cylinder is a second blanket cylinder and in order to bring about the difference in velocity Δω between the first and second blanket cylinders, the angular adaptation value is determined as a function of a first feed coefficient C1 associated with the first blanket of the first blanket cylinder and as a function of a second feed coefficient C2 associated with a second blanket of the second blanket cylinder, each feed coefficient indicating the guiding behavior of the associated blanket relative to a web to be printed.

24. The method according to claim 23, wherein the angular adaptation value is a function of the difference between the feed coefficient C1 and the feed coefficient C2.

25. The method according to claim 21, wherein a difference in angular velocity between the first blanket cylinder and the plate cylinder is brought about by a first predetermined angular adaptation value, and at the same time a difference in angular velocity between the first blanket cylinder and the impression cylinder is brought about by a second predetermined angular adaptation value, the second angular adaptation value being different from the first angular adaptation value.

26. The method according claim 21, wherein the angular adaptation value is from 2.5×10−6 to 2.5×10−5 radians and/or corresponds to an adaptation distance on a circumference of the corresponding cylinder which is from 0.5 μm to 5 μm.

27. The method according claim 26, wherein the angular adaptation value is in the order of 5×10−6 radians.

28. The method according claim 25, wherein each angular adaptation value is from 2.5×10−6 to 2.5×10−5 radians and/or corresponds to an adaptation distance on a circumference of the corresponding cylinder which is from 0.5 μm to 5 μm.

29. The method according claim 28, wherein the angular adaptation value is in the order of 5×10−6 radians.

30. The method according to claim 18, wherein the plate cylinder is driven individually by a first motor, and wherein the first blanket cylinder and the impression cylinder are driven either by a second common motor or by two further individual motors, the or each difference in velocity Δω being obtained by regulating the motors.

31. The method according to claim 18, wherein during the printing operation, the blanket is secured to the blanket cylinder in a manner which is immobile in the circumferential direction relative to the blanket cylinder.

32. The method according claim 18, wherein |Δω|=|ω1−ω2×D2/D1|>0 throughout the entire duration of the regulating step.

33. The method according to claim 18, wherein the regulating step comprises at least two regulating sub-steps during which |Δω|>0 and at least one synchronous sub-step during which Δω=0.

34. The method according to claim 33 wherein the at least two regulating sub-steps delimit the regulating step.

35. A device for regulating the angular velocity of one or more printing cylinders in a printing machine, the device carrying out the method according to claim 18.

36. Computer readable media, having stored thereon, computer executable instructions for performing a method comprising the method claim 18.

37. A method for regulating a rotary press with a web, the press including a first printing unit and a second printing unit:
the first printing unit including:
a plate cylinder having a first plate angular printing velocity ω2 and a first plate nominal diameter D2,
a first blanket cylinder carrying a tubular blanket, defining a region of contact with the plate cylinder and having a first blanket angular printing velocity ω1 and a first blanket nominal diameter D1; and
the second printing unit including:
a second blanket cylinder having a second blanket angular printing velocity ω1′ and a second blanket nominal diameter D1′,
the method comprising the step of:
regulating the second blanket angular printing velocity ω1′ relative to the first blanket angular printing velocity col for a duration greater than or equal to six minutes when the first and second printing units are printing, the ratio ω1′/ω1 of the angular velocities being different from the ratio D1/D1′ between the nominal diameters in order to define a difference in velocity Δω=ω1′−ω1×D1/D1′ for at least part of the duration, any difference in velocity Δω0 being of a same sign throughout the entire duration of the regulating step.

38. The method according to claim 37, wherein the first printing unit and the second printing unit are two consecutive units, the first blanket cylinder and the second blanket cylinder each printing a partial image on a same side of the web, the difference in velocity Δω between the first blanket cylinder and the second blanket cylinder being regulated to keep constant or to regulate to a predetermined value

39. The method according to claim 38 wherein the predetermined value is a tension of the web between the first printing unit and the second printing unit.

40. The method according to claim 37, wherein a difference in angular velocity between the first blanket cylinder and the plate cylinder is brought about by a first predetermined angular adaptation value, and at the same time a difference in angular velocity between the second blanket cylinder and the first blanket cylinder is brought about by a third predetermined angular adaptation value, the third angular adaptation value being different from the first angular adaptation value.

41. The method according to claim 40, wherein the first printing unit includes an impression cylinder defining a region of counter-pressure with the first blanket cylinder, a difference in angular velocity between the first blanket cylinder and the impression cylinder is brought about by a second predetermined angular adaptation value, the second angular adaptation value being different from the first angular adaptation value, the third angular adaptation value being different from the second angular adaptation value.

42. The method according claim 41, wherein each angular adaptation value is from 2.5×10−6 to 2.5×10−5 radians and/or corresponds to an adaptation distance (ε) on the circumference of the associated cylinder which is from 0.5 μm to 5 μm.

43. The method according to claim 42 wherein each angular adaptation value is in the order of 5×10−6 radians.

44. The method according to claim 37, wherein during the printing operation, the first and second blankets are secured to the first and second blanket cylinders respectively in a manner which is immobile in the circumferential direction relative to the first and second blanket cylinders respectively.

45. A method for regulating a printing unit comprising the steps of:
printing with a printing unit; and
regulating the printing unit for a duration of six minutes or more;
the printing unit including a plate cylinder, blanket cylinder and impression cylinder, each cylinder having a corresponding angular velocity and a corresponding nominal diameter, the blanket cylinder contacting the plate cylinder during printing, the impression cylinder applying counter-pressure to the blanket cylinder during printing,
for at least part of the duration of the regulating step, a ratio of the blanket cylinder angular velocity col to the plate cylinder angular velocity ω2 being different from a ratio of the plate cylinder nominal diameter D2 to the blanket cylinder nominal diameter D1 to define a difference in velocity Δω, wherein Δω=ω1−ω2×D2/D1,
any difference in velocity Δω being positive or negative for the entire duration of the regulating step.

46. A method for regulating a printing unit comprising the steps of:
printing with a printing unit; and
regulating the printing unit for a duration of six minutes or more;
the printing unit including a plate cylinder, blanket cylinder and impression cylinder, each cylinder having a corresponding angular velocity and a corresponding nominal diameter, the blanket cylinder contacting the plate cylinder during printing, the impression cylinder applying counter-pressure to the blanket cylinder during printing,
for at least part of the duration of the regulating step, a ratio of the impression cylinder angular velocity ω3 to the blanket cylinder angular velocity col being different from a ratio of the blanket cylinder nominal diameter D1 to the impression cylinder nominal diameter D3 to define a difference in velocity Δω, wherein 66 ω=ω−ω1×D1/D3,
any difference in velocity Δω being positive or negative for the entire duration of the regulating step.
